(19) United States
(12) Patent Application Publication
(10) Pub. No.: US 2026/0296628 A1
(43) Pub. Date: Oct. 1, 2026

(54) FLOOR COMPRISING AT LEAST ONE HEIGHT-ADJUSTABLE FIXING DEVICE, AIRCRAFT COMPRISING SAID FLOOR

(71) Applicant: Airbus Operations (S.A.S.), Toulouse (FR)

(72) Inventors: Valentina Spinoglio, Toulouse (FR); Benjamin Boisnier, Toulouse (FR)

(21) Appl. No.: 19/453,526

(22) Filed: Jan. 20, 2026

(30) Foreign Application Priority Data
Jan. 24, 2025 (FR) FR2500753

(51) Int. Cl. B64C 1/18

(52) U.S. Cl. CPC B64C 1/18

(57) ABSTRACT

A floor includes at least one fixing device connecting a panel and a framework and including a shank having a longitudinal axis, a first and a second stop which immobilize the shank with respect to the panel and the framework, respectively, and at least one spacer, interposed between the panel and the framework, which includes a first part configured to be directly or indirectly in abutment against the panel, a second part configured to be directly or indirectly in abutment against the framework, and a helical connection connecting the first and the second part and allowing the length of the spacer to be adjusted. An aircraft including at least one such floor is also disclosed.

### TECHNICAL FIELD

The subject matter herein relates to a floor comprising at least one height-adjustable fixing device and to an aircraft comprising the floor.

### BACKGROUND

According to an embodiment visible in FIG. 1, a floor 10 comprises:
a. a framework comprising beams parallel to one another and oriented in a first direction and rails 12 parallel to one another and oriented in a second direction perpendicular to the first direction,
b. panels 14 supported by the rails 12,
c. fixing devices 16 connecting the panels 14 to the rails 12.

These fixing devices 16, in the form of bolts, are regularly distributed along the rails 12.

Because of the dimensional variations during the manufacture of the framework, the panel 14 is not perfectly pressed against the rails 12 before the fixing devices 16 are installed. With certain fixing devices 16, a gap may remain between the rail 12 and the panel 14. To fill this gap prior to installing the panel 14, the operator in charge of fixing the panel 14 must assess the value of the gap between the panel 14 and the rail 12 at each fixing device 16 in order to select the most appropriate wedge 18 to fill this gap, install the various wedges 18, position the panel 14 and then install the various fixing devices 16. If a gap has been incorrectly assessed and the thickness of the wedge 18 is not equal to that of the gap, then it is necessary to disassemble all the fixing devices, remove the panel, swap the inappropriate wedge 18 with one whose value is equal to that of the gap, reposition the panel 14 and then replace all the fixing devices 16.

Consequently, the installation of the panels takes a relatively long amount of time and requires a great deal of dexterity or experience in order to assess the thickness of the various wedges 18.

### SUMMARY

The disclosure herein aims to remedy all or some of the drawbacks of the prior art.

To this end, the disclosure herein relates to a floor comprising at least one framework, at least one panel supported by the framework and at least one fixing device connecting the panel and the framework, the fixing device comprising a shank having a longitudinal axis, a first stop which cooperates with the panel and immobilizes the shank with respect to the panel, a second stop which cooperates with the framework and immobilizes the shank with respect to the framework and at least one spacer interposed between the panel and the framework, with the panel comprising a first through-hole for accommodating the shank.

According to the disclosure herein, the spacer comprises a first part configured to be directly or indirectly in abutment against the panel, a second part configured to be directly or indirectly in abutment against the framework and a helical connection connecting the first and the second part.

The spacer interposed between the panel and the framework can be adjusted in length, which allows its length to be precisely set according to the gap between the panel and the framework, this adjustment being carried out after the panel has been placed on the framework and before it is fixed.

According to another feature, the first part comprises a cylindrical and tapped inner face that forms a housing configured to at least partially accommodate the second part and the shank. In addition, the second part is tubular and comprises cylindrical and substantially concentric inner and outer faces, the inner face having a diameter greater than or equal to that of the shank, the outer face of the second part being at least partially threaded and having a suitable diameter enabling it to cooperate with the tapped inner face of the first part, the tapped inner face of the first part and the threaded outer face of the second part forming the helical connection of the spacer.

According to another feature, the inner face has a portion which extends from a transverse end face of the second part oriented towards the panel and has a prismatic section configured to allow the second part to be pivoted with a suitable tool.

According to another feature, the second part has a collar on a transverse end face oriented towards the framework, which collar has a diameter greater than that of the outer face.

According to another feature, the inner face of the first part comprises a flared shape for at least partially accommodating the collar.

According to another feature, the first through-hole of the panel is dimensioned to at least partially accommodate the first part of the spacer.

According to another feature, the first part of the spacer is connected to the panel by adhesive bonding or the first part is force-fitted into the first through-hole.

According to another feature, the spacer is positioned between the framework and a first surface of the panel oriented towards the framework.

According to another feature, the fixing device comprises a rotation immobilization system configured to immobilize the second part of the spacer in rotation.

According to another feature, the rotation immobilization system comprises at least one radial extension integral with the first part and at least one screw connecting the radial extension and the panel or a fixed element integral with the panel.

According to another feature, the floor comprises a rigid plate interposed between the panel and the framework, at least one bolt, without a spacer that is adjustable in length, connecting the rigid plate and the panel, and at least one fixing device incorporating a spacer that is adjustable in length and connecting the panel and the rigid plate to the framework.

The disclosure herein also relates to an aircraft comprising at least one floor according to one of the preceding features.

### BRIEF DESCRIPTION OF THE DRAWINGS

Further features and advantages will become apparent from the following description of the disclosure herein, which is given by way of example only, with reference to the appended drawings, in which:

FIG. 1 is a perspective view of a part of a floor according to one embodiment of the prior art;

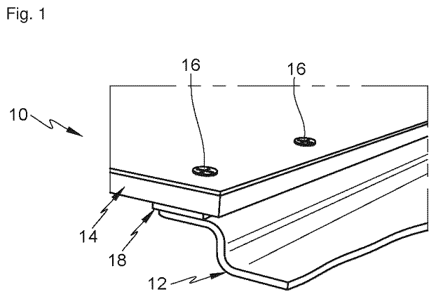

FIG. 2 is a perspective view of a part of an aircraft floor, illustrating one embodiment of the disclosure herein;

FIG. 3 is a perspective view of a disassembled panel, illustrating one embodiment of the disclosure herein;

FIG. 4 is a perspective view of a part of the floor in the disassembled state, illustrating one embodiment of the disclosure herein;

FIG. 5 is a perspective view of a fixing device, illustrating a first embodiment of the disclosure herein;

FIG. 6 is a longitudinal section through the fixing device visible in FIG. 5;

FIG. 7 is a cross section of the fixing device visible in FIG. 5 in a first state to compensate for a maximum gap in part (A) and a minimum gap in part (B);

FIG. 8 is a perspective view of a part of the floor visible in FIG. 2 during a step of adjusting the height of the fixing device visible in FIG. 5;

FIG. 9 is a perspective view of a fixing device, illustrating a second embodiment of the disclosure herein;

FIG. 10 is a perspective view of the fixing device visible in FIG. 9, in the disassembled state;

FIG. 11 is a longitudinal section through the fixing device visible in FIG. 9;

FIG. 12 is a cross section of the fixing device visible in FIG. 9 in a first state to compensate for a maximum gap in part (A) and a minimum gap in part (B); and

FIG. 13 is a perspective view of a part of a floor during a step of adjusting the height of the fixing device visible in FIG. 9.

### DETAILED DESCRIPTION

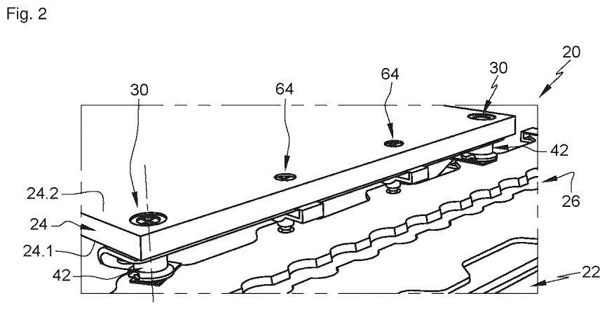

According to an embodiment visible in FIG. 2, a floor 20 comprises at least one framework 22 and at least one panel 24 fixed to the framework 22.

According to one application, an aircraft comprises at least one such floor 20.

According to one embodiment, the framework 22 comprises beams (not shown) parallel to one another and oriented in a first direction and rails 26 parallel to one another and oriented in a second direction that is perpendicular to the first direction. The rails 26 may be designed for securing seats or chairs to them in the case of an aircraft floor.

The rail 26 has a substantially horizontal wing 28 which has a first face 28.1 oriented towards the panel 24 and a second face 28.2 opposite the first face 28.1 and substantially parallel to the latter.

The panel 24 may comprise one or more layers. It comprises a first surface 24.1 oriented towards the framework 22 and a second surface 24.2 opposite the first surface 24.1 and substantially parallel to the latter.

The floor 20 comprises at least one fixing device 30 for connecting the panel 24 and the framework 22, more particularly the wing 28 of the rail 26, which comprises a shank 32 having a longitudinal axis A32, a first stop 34 cooperating with the panel 24 and immobilizing the shank 32 with respect to the panel 24, and a second stop 36 cooperating with the framework 22 and immobilizing the shank 32 with respect to the framework 22.

For the remainder of the description, a longitudinal direction is parallel to the longitudinal axis A32.

According to one configuration, the first stop 34 is a head integral with the shank 32 which forms one and the same part with the latter. The shank 32 is at least partially threaded. The shank 32 and the first stop 34 form a screw 38.

For each fixing device 30, the panel 24 comprises a first through-hole 24.3, which connects the first and the second surface 24.1, 24.2 and is provided to accommodate the shank 32. In parallel, the wing 28 of the framework 22 comprises a second through-hole 28.3 provided to accommodate the shank 32.

According to one arrangement, the first stop 34 is a countersunk head. In addition, the first through-hole 24.3 of the panel 24 opens out at the second surface 24.2 via a frustoconical portion configured to accommodate the countersunk head of the screw 38.

Of course, the disclosure herein is not limited to this embodiment for the first stop 34.

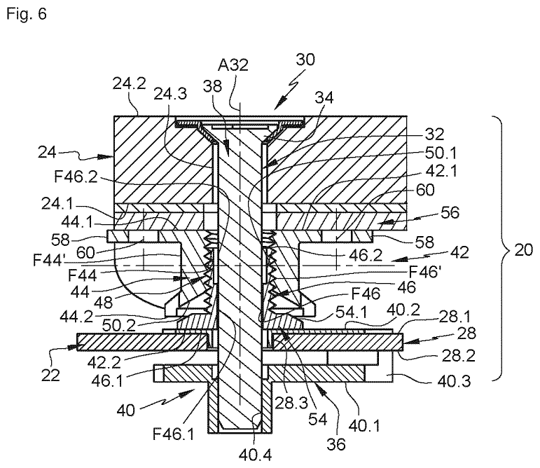

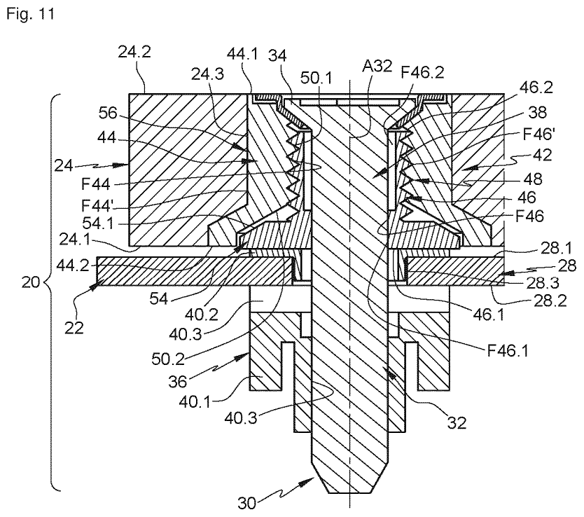

According to an embodiment visible in FIGS. 6 and 11, the second stop 36 is a floating nut 40. The latter comprises a first and a second branch 40.1, 40.2 positioned on either side of the wing 28 of the framework 22 and connected by a base 40.3, with one of the branches 40.1 having a tapped hole 40.4 configured to cooperate with the partially threaded shank 32 in order to screw it in or to unscrew it. According to this embodiment, the wing 28 of the framework 22 is immobilized in translation in the longitudinal direction between the first and the second branch 40.1, 40.2 of the floating nut 40. This configuration makes it possible to immobilize the floating nut 40 in rotation with respect to the wing 28 of the framework 22. Thus, it is possible to screw in the shank 32 only from its part that is accessible from above the panel 24.

Of course, the disclosure herein is not limited to this embodiment for the second stop 36.

The fixing device 30 comprises a tubular spacer 42 that is adjustable in length, interposed between the panel 24 and the framework 22 and positioned around the shank 32. This spacer 42 extends between a first end 42.1 oriented towards the panel 24 or the first stop 34 and a second end 42.2 oriented towards the framework 22 and has a length corresponding to a dimension separating the first and the second end 42.1, 42.2. The first and the second end 42.1, 42.2 are positioned in transverse planes parallel to one another and substantially perpendicular to the longitudinal axis A32 when the spacer 42 is positioned around the shank 32. In operation, the first end 42.1 is pressed against the panel 24 or against a part itself pressed against the panel 24. The second end 42.2 is pressed against the wing 28 of the framework 22 or against a part itself pressed against the wing 28 of the framework 22.

The spacer 42 comprises a first part 44 configured to be directly or indirectly in abutment against the panel 24, a second part 46 configured to be directly or indirectly in abutment against the framework 22 and a helical connection 48 connecting the first and the second part 44, 46. Thus, a rotational movement of one of the first and the second part 44, 46 causes a movement in the longitudinal direction of the first part 44 with respect to the second part 46, or vice versa, so as to cause the first and the second end 42.1, 42.2 to move away from or closer to one another. Since this spacer 42 is interposed between the panel 24 and the framework 22, it is possible to fill the gap between the panel 24 and the framework 22 perfectly by adjusting the length of the spacer 42 by pivoting its first and its second part with respect to one another.

The first part 44 is tubular, extends between a first transverse end face 44.1 which corresponds to the first end 42.1 of the spacer 42 and a second transverse end face 44.2, and comprises cylindrical and substantially concentric inner and outer faces F44, F44′ connecting the first and the second transverse end face 44.1, 44.2, with the inner face F44 being tapped. The inner face F44 delimits a cavity for at least partially accommodating the second part 46 and the shank 32.

According to one embodiment, the first part 44 comprises a cylindrical portion 50.1 which extends from the first transverse end face 44.1 and a frustoconical portion 50.2 which extends from the cylindrical portion 50.1 to the second transverse end face 44.2. Thus, the inner face F44 flares out at the second transverse end face 44.2.

The second part 46 is tubular, extends between a first transverse face 46.1 which corresponds to the second end 42.2 of the spacer 42 and a second transverse end face 46.2 oriented towards the panel 24, and comprises cylindrical and substantially concentric inner and outer faces F46, F46′ connecting the first and the second transverse end face 46.1, 46.2. The inner face F46 has a diameter greater than or equal to that of the shank 32. The outer face F46′ of the second part 46 is at least partially threaded and has a diameter enabling it to cooperate with the tapped inner face F44 of the first part 44. The tapped inner face F44 of the first part 44 and the threaded outer face F46′ of the second part 46 form the helical connection 48 of the spacer 42.

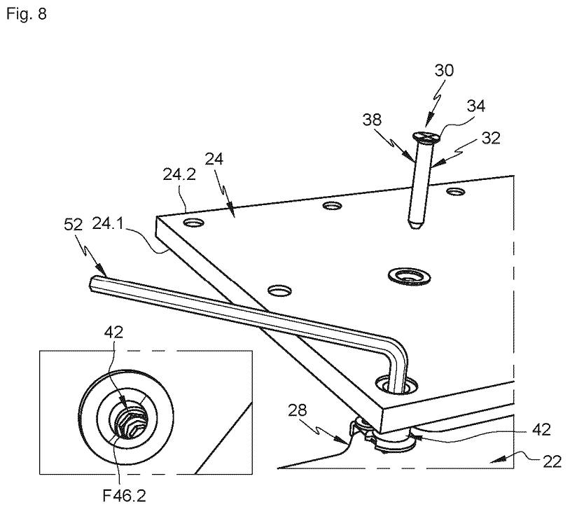

The inner face F46 has a cylindrical and smooth first portion F46.1 which extends from the first transverse end face 46.1 and a second portion F 46.2 which extends from the second transverse end face 46.2 to the first portion F 46.1, the second portion F46.2 having a prismatic section configured to enable the second part 46 to be pivoted with respect to the first part 44 with a suitable tool 52 (visible in FIG. 8) in order to be screwed in or to be unscrewed. According to one configuration, the second portion F46.2 has a hexagonal section and the tool 52 is a hexagon key. Of course, the disclosure herein is not limited to this configuration for the section of the second portion F46.2.

According to one embodiment, the second part 46 has a collar 54, at its first transverse end face 46.1, which has a diameter greater than that of the outer face F46′. This collar makes it possible to increase the surface area of the second part 46 in contact with the wing 28 of the framework 22 and/or the second stop 36. According to one configuration, the collar 54 has a bevelled edge 54.1 so as to cooperate with the frustoconical shape of the inner face F44 of the first part 44. Thus, the inner face F44 of the first part 44 has a flared shape to at least partially accommodate the collar 54, which contributes to obtaining a more compact spacer 42.

The fixing device 30 comprises a rotation immobilization system 56 configured to immobilize the second part 44 of the spacer 42 in rotation.

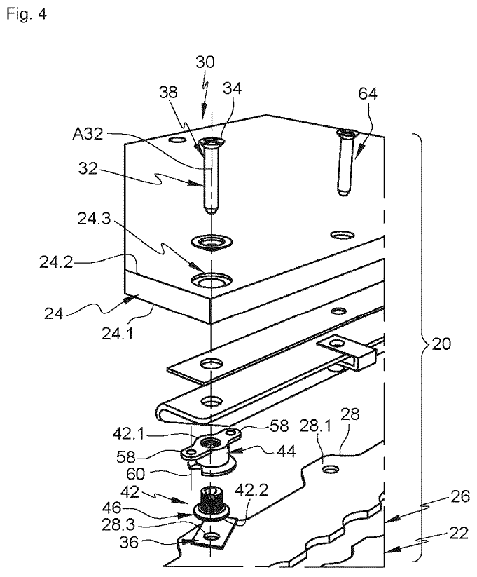

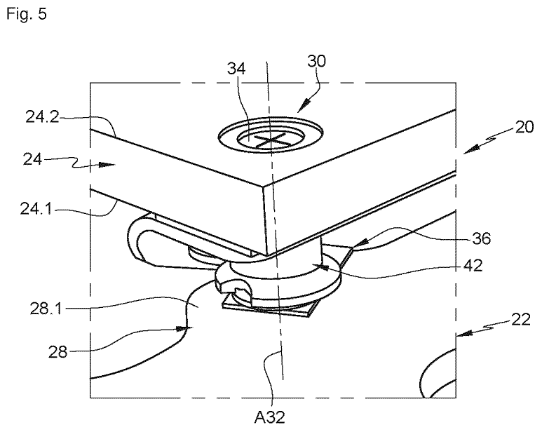

According to a first embodiment visible in FIGS. 2 to 8, the spacer 42 is positioned between the framework 22 and the panel 24, more particularly between the first surface 24.1 of the panel 24 and the first face 28.1 of the wing 28 of the framework 22. According to this first embodiment, the rotation immobilization system 56 comprises at least one radial extension 58 integral with the first part 44 and at least one screw 60 connecting the radial extension 58 and the panel 24 or a fixed element integral with the panel 24. According to one configuration, the rotation immobilization system 56 comprises two radial extensions 58 forming a single piece with the first part 44.

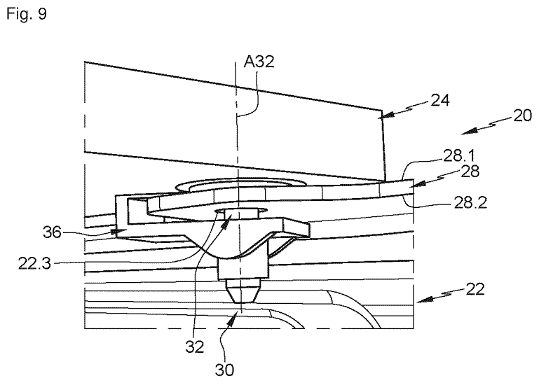

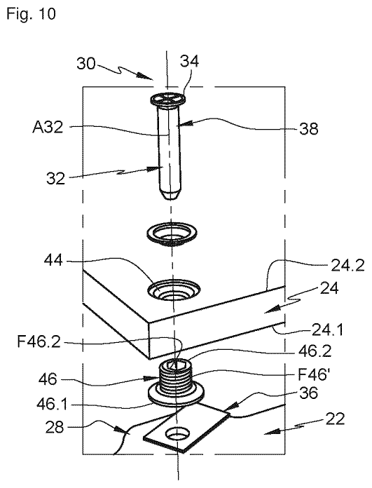

According to a second embodiment visible in FIGS. 9 to 13, the panel 24 comprises a housing configured to at least partially accommodate the spacer 42. According to this second embodiment, the first through-hole 24.3 of the panel 24 is dimensioned to at least partially accommodate the first part 44 of the spacer 42. Thus, the first through-hole 24.3 has a diameter substantially identical to that of the outer face F44 of the first part 44 of the spacer 42.

According to this second embodiment, the first part 44 of the spacer 42 is connected to the panel 24 by adhesive bonding or the first part 44 is force-fitted into the first through-hole 24.3 in the manner of an insert.

Of course, the disclosure herein is not limited to these embodiments for immobilizing the first part 44 of the spacer 42 in rotation.

According to one embodiment, the fixing device 30 comprises a ring 66 interposed between the screw 38 on the one hand and the panel 24 and/or the first part 44 of the spacer 42 on the other.

According to one arrangement, all the connecting devices connecting the panels 24 and the framework 22 each comprise a spacer 42 that is adjustable in length.

According to another arrangement visible in FIGS. 2 to 4, the floor 20 comprises a rigid plate 62, such as an L-shaped angle bracket for example, interposed between the panel 24 and the framework 22. The floor 30 comprises at least one bolt 64, without a spacer that is adjustable in length, connecting the rigid plate 62 and the panel 24 and at least one fixing device 30 incorporating a spacer 42 that is adjustable in length and connecting the panel 24 and the rigid plate 62 to the framework 22. According to this arrangement, the first part 44 of the spacer 42 of each fixing device 30 is connected to the rigid plate 62 in order to immobilize it in rotation.

By way of example, each bolt 64 without a spacer 42 comprises a screw and a floating nut integral with the framework 22 and more particularly with the wing 28 of the framework 22.

Unlike the framework 22, the rigid plate 62 has a flatness conforming to that of the first surface 24.1 of the panel so that the rigid plate 62 is pressed over its entire surface area against the panel 24. According to one embodiment, two bolts 64, without a spacer that is adjustable in length, are interposed between two fixing devices 30 incorporating a spacer 42 that is adjustable in length.

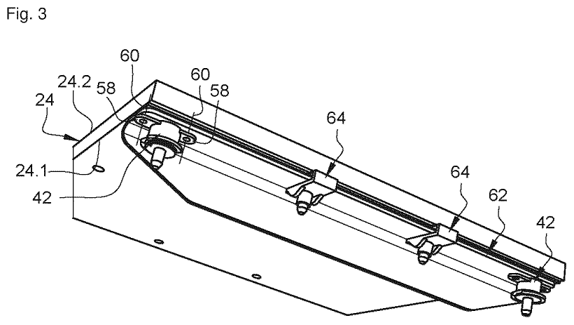

A method of installing a panel 24 comprises a step of fixing the spacers 42 of the fixing devices 30 to the rigid plate 62, a step of fixing the rigid plate 62 to the panel 24 with bolts 64 without a spacer that is adjustable in length, as illustrated in FIG. 3, and a step of installing the panel 24 on the framework 22, with the shanks 32 being removed.

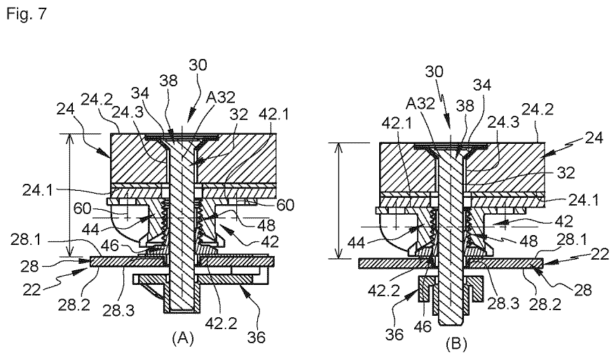

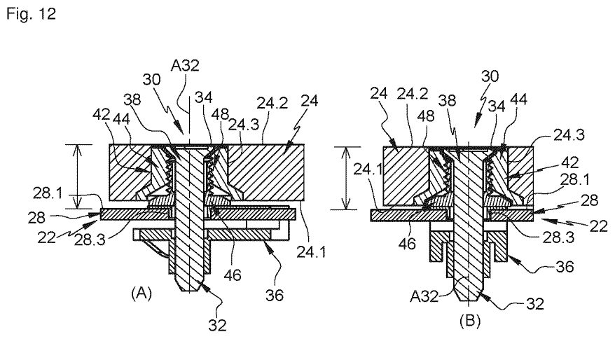

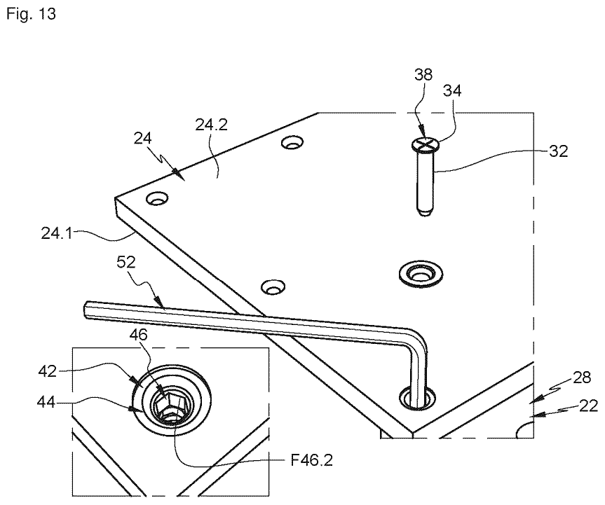

Then, as shown in FIGS. 8 and 13, the spacers 42 are adjusted in length. To this end, the second part 46 of each spacer 42 is rotated by a tool 52, such as an Allen key, Torx® key, Ribe® key, XZN wrench or a flat screwdriver or any other suitable tool. Thus, the length of the spacer 42 can be adjusted between a maximum value visible in parts (A) of FIGS. 7 and 12 and a minimum value visible in parts (B) of FIGS. 7 and 12.

Each spacer 42 can be precisely adjusted so as to fill the gap between the panel 24 and the framework 22. Finally, the shanks 32 of the various fixing devices 30 are screwed in so as to connect the panel 24 to the framework 22, as illustrated in FIGS. 2, 5, 9 and 11.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A floor comprising at least one framework, at least one panel supported by the framework and at least one fixing device connecting the panel and the framework, the fixing device comprising a shank having a longitudinal axis, a first stop which cooperates with the panel and immobilizes the shank with respect to the panel, a second stop which cooperates with the framework and immobilizes the shank with respect to the framework, and at least one spacer interposed between the panel and the framework, with the panel comprising a first through-hole for accommodating the shank; wherein the spacer comprises a first part configured to be directly or indirectly in abutment against the panel, a second part configured to be directly or indirectly in abutment against the framework, and a helical connection connecting the first and the second part.

2. The floor according to claim 1, wherein the first part comprises a cylindrical and tapped inner face that forms a housing configured to at least partially accommodate the second part and the shank, and wherein the second part is tubular and comprises cylindrical and substantially concentric inner and outer faces, the inner face having a diameter greater than or equal to that of the shank, the outer face of the second part being at least partially threaded and having a diameter enabling it to cooperate with the tapped inner face of the first part, the tapped inner face of the first part and the threaded outer face of the second part forming the helical connection of the spacer.

3. The floor according to claim 2, wherein the inner face has a portion which extends from a transverse end face of the second part oriented towards the panel and has a prismatic section configured to allow the second part to be pivoted with a suitable tool.

4. The floor according to claim 2, wherein the second part has a collar on a transverse end face oriented towards the framework, which collar has a diameter greater than that of the outer face.

5. The floor according to claim 4, wherein the inner face of the first part comprises a flared shape for at least partially accommodating the collar.

6. The floor according to claim 1, wherein the first through-hole of the panel is dimensioned to at least partially accommodate the first part of the spacer.

7. The floor according to claim 6, wherein the first part of the spacer is connected to the panel by adhesive bonding or the first part is force-fitted into the first through-hole.

8. The floor according to claim 1, wherein the spacer is positioned between the framework and a first surface of the panel oriented towards the framework.

9. The floor according to claim 8, wherein the fixing device comprises a rotation immobilization system configured to immobilize the second part of the spacer in rotation.

10. The floor according to claim 9, wherein the rotation immobilization system comprises at least one radial extension integral with the first part and at least one screw connecting the radial extension and the panel or a fixed element integral with the panel.

11. The floor according to claim 1, wherein the floor comprises a rigid plate interposed between the panel and the framework, at least one bolt, without a spacer that is adjustable in length, connecting the rigid plate and the panel, and at least one fixing device incorporating a spacer that is adjustable in length and connecting the panel and the rigid plate to the framework.

12. An aircraft comprising at least one floor according to claim 1.
